(19) United States
(12) Patent Application Publication
(10) Pub. No.: US 2009/0244759 A1
(43) Pub. Date: Oct. 1, 2009

(54) CORRECTION INFORMATION RECORDING METHOD, CORRECTION INFORMATION RECORDING CIRCUIT AND INFORMATION STORAGE DEVICE

(75) Inventor: Kazunori MORI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/412,747

(22) Filed: Mar. 27, 2009

(30) Foreign Application Priority Data
Mar. 31, 2008 (JP) 2008-92645

(51) Int. Cl. G11B 5/09

(52) U.S. Cl. 360/47; G9B/5.033

(57) ABSTRACT

A method and device of recording RRO correction information including recording first RRO correction information on a first track in one of servo frames of a recording medium and recording second RRO correction information on a second track different from the first recording track at a position different from a position of the first RRO correction information with respect to a peripheral direction.

### CROSS-REFERENCE TO RELATED APPLICATIONS

This application is based upon and claims the benefit of priority from the prior Japanese Patent Application No. 2008-92645 filed on Mar. 31, 2008, the entire contents of which are incorporated herein by reference.

### BACKGROUND

1. Field

The embodiment(s) discussed herein are related to correction information, and more particularly a RRO correction information recording method, a RRO correcting information recording circuit and an information storage device for correcting Repeatable Run Out (hereinafter referred to as “RRO”) between a position of a head and a track center.

2. Description of the Related Art

The information amount has increased more and more in connection with development of the information society. In accordance with the increase of the information amount, developments of large-capacity and low-price storage devices have been required. Particularly, magnetic discs in which information access is carried out through magnetic field have been noted as information-rewritable high-density recording media, and a magnetic disc which contains a magnetic disc and a head and carries out information access to the magnetic disc by the head has been actively studied and developed to further increase the capacity.

TPI (the number of tracks per inch) is increased or the like as a method of enhancing the capacity of the magnetic disc device. In this case, the distance between neighboring tracks (track pitch) is reduced, and thus the magnetic head is required to surely apply magnetic field to only a track on which information is written. With respect to the magnetic disc, the storage area is normally divided into plural areas (sectors) in the peripheral direction of the track, and a servo frame constructed by a preamble for adjusting the frequency and the amplitude, a servo mark having a data pattern common to all sectors, a gray code representing a track number, PES data representing the displacement amount from the track center (Position Error Signal), etc. is recorded at the head of each sector in advance before the magnetic disc device is shipped. With respect to the magnetic head, a servo frame is obtained before an information access is carried out, and the magnetic head is positioned onto a target track of the magnetic disc on the basis of the servo frame.

However, the servo frame is not necessarily stably recorded due to vibration of a servo track writer for recording servo frames on a magnetic disc, displacement of the rotational axis of the magnetic disc when the magnetic disc is mounted on the servo track writer or the like, and the locus of the track center which is represented by the PES data in the servo frame represents rugged positional displacement from the circle of the actual track center. This positional displacement repetitively occurs in the same way with one revolution of the magnetic disc as a period, and thus it is called as RRO (Repeatable Run Out). In the case of large RRO, when the magnetic head is positioned while following the servo frame, the magnetic head approaches another track which is generally adjacent to a target track, and thus there is a risk that data is erroneously overwritten on data recorded on a track different from the target track. In order to avoid such a trouble, it is necessary to sufficiently increase the track pitch, and thus there is a problem that the recording capacity of the magnetic disc is lowered.

In order to solve this problem, RRO correction data representing the locus of RRO of each track is recorded at the last position of the servo frame, and when information access is actually carried out, the magnetic head is positioned while the positional displacement represented by the RRO correction data is cancelled (for example, Japanese Laid-open Patent Publication No. 9-330571).

FIG. 1 is a diagram showing an example of the track format of the magnetic disc.

As shown in FIG. 1, plural concentric tracks 11 are provided on the magnetic disc 10, and the recording area of the magnetic disc 10 is divided into plural sectors.

A servo frame 12 constructed by position data 12a for detecting the position of the magnetic head 20 and RRO correction data 12b is recorded at the head of each sector, and user data 13 as an access target is recorded subsequently to the servo frame 12. The position data 12a can be read out even when the magnetic head 20 is located at any position above the magnetic disc 10, and thus the position of the magnetic head 20 can be detected.

When the magnetic disc 10 rotates in the direction of an arrow A, the magnetic head 20 is first moved in a radial direction (the direction of an arrow B), and data as an information access target is positioned onto a recorded target track 11.

FIG. 2 is a diagram showing one track 11 on the magnetic disc 10 shown in FIG. 1, and FIG. 3 is a diagram showing one track 11′ on a magnetic disc 10′ whose track pitch is reduced.

With respect to the magnetic head 20 shown in FIG. 2, information access can be carried out on the RRO correction data 12b and the user data 13 which are recorded within a track pitch W1 containing the actual track center O. Furthermore, the positions P1, P2 of the track center which are represented by PES data in the position data 12a are displaced from the actual track center O, and the positional displacement amounts W2, W3 of these displacements are recorded as the RRO correction data 12b.

When the magnetic head 20 is positioned onto the target track 11, the positional displacement amounts W2, W3 represented by the RRO correction data 13 are canceled from the positions P1, P2 of the track center represented by the PES data in the position data 12a, and the position of the magnetic head 20 is finely adjusted in the radial direction (in the direction of the arrow B). The magnetic disc 10 is rotated in the direction of the arrow A, and the magnetic head 20 is positioned on the basis of the position data 12a and the RRO correction data 12b, whereby the magnetic head 20 is apparently moved along the track center O in the direction of an arrow A′.

The correction of the positional displacement using the RRO correction data 12b is possible only when the magnetic head 20 is located within a correction range W5 containing the track center O as the center thereof. When the magnetic head 20 is located within an on-track width W4 which is set to a predetermined multiple of the correction range W5, it is judged that the magnetic head 20 is positioned onto the track 11. The correction range W5 and the on-track width W4 are determined by a vibration degree of the servo track writer for recording the position data 12, etc., and when the magnetic head 20 is located within the on-track width W4, it is necessary to surely read out the RRO correction data 12b.

As described above, in order to increase the capacity of the magnetic disc device, it has been recently widely adopted to increase TPI of the magnetic disc. When TPI of the magnetic disc is increased, the track pitch W1′ is narrowed as shown in FIG. 3. However, it is difficult to perfectly prevent the vibration of the servo track writer, the displacement of the rotational axis of the magnetic disc, etc., and it is still the case that the correction range W5 and the on-track width W4 described above are not correspondingly reduced from ranges in the typical arts.

As described above, when the track pitch W1′ is narrowed, the correction range W5 of the RRO correction data 12b to the track pitch W1′ is relatively increased, and the on-track width W4 exceeds the track pitch W1′. Therefore, another track adjacent to a target track 11′ enters the on-track width W4 on the target track 11′. Therefore, even when a magnetic head 20′ moves to a position above the adjacent track, it is judged that the magnetic head 20′ is located above the target track 11′. As a result, erroneous RRO correction data 12b is read out by the magnetic head 20′, and the magnetic head 20′ is positioned on the basis of the erroneous RRO correction data 12b. Accordingly, data recorded on the adjacent track may be overwritten or the access performance may be deteriorated.

### SUMMARY

According to an embodiment of the present invention, a method of recording RRO correction information has operations including recording first RRO correction information on a first track in one of servo frames of a disc medium and recording second RRO correction information on a second track different from a first recording track at a position different from a position of the first RRO correction information with respect to a peripheral direction.

It is to be understood that both foregoing general descriptions and the following detailed description are exemplary and explanatory and are not restrictive of invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram showing an example of a track format of a magnetic disc;

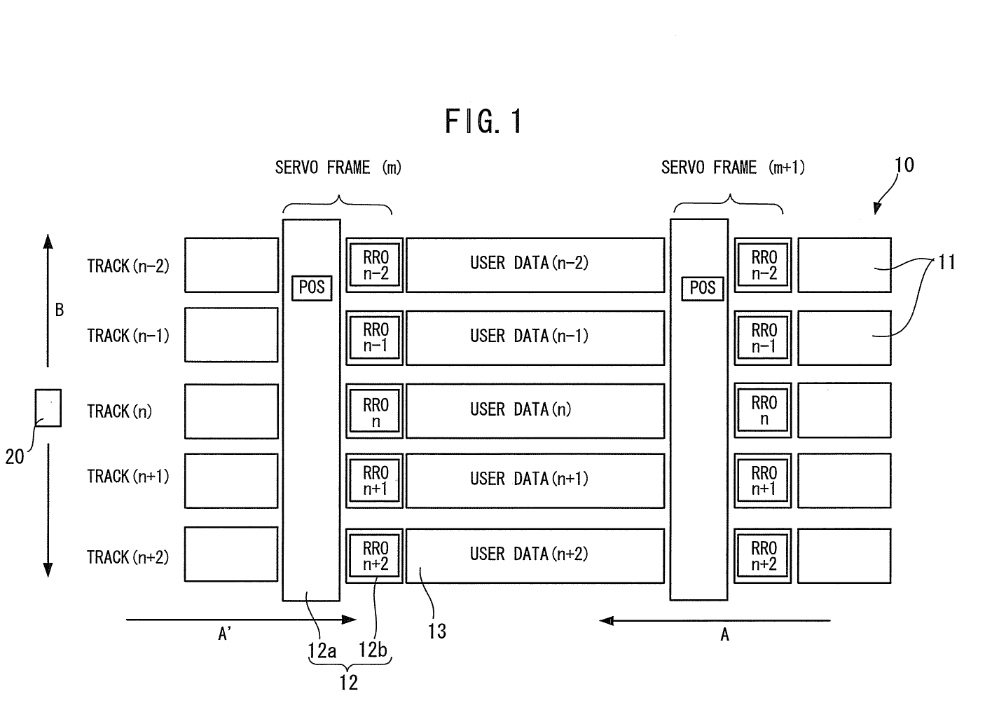

FIG. 2 is a diagram showing one track on a magnetic disc shown in FIG. 1;

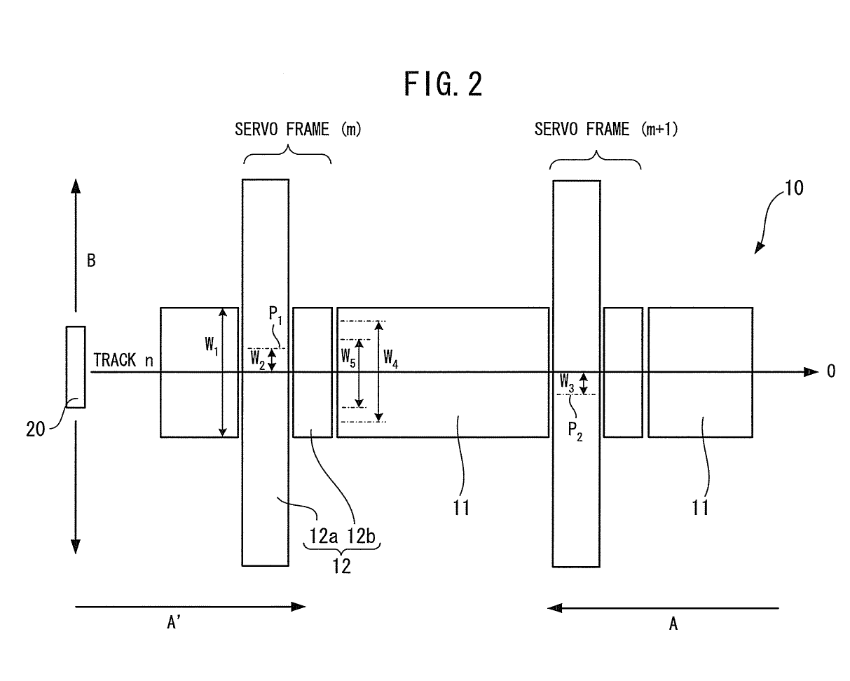

FIG. 3 is a diagram showing one track on a magnetic disc whose track pitch is narrowed;

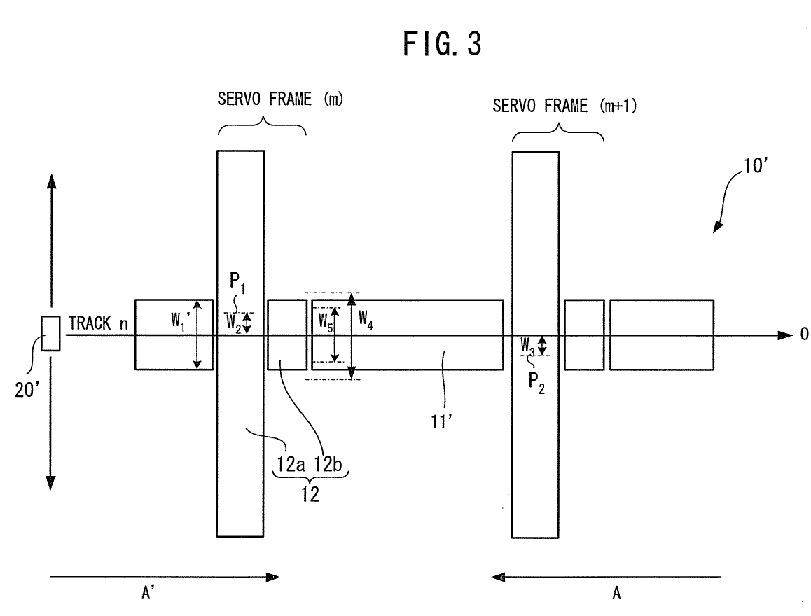

FIG. 4 is a diagram showing data recorded on a magnetic disc;

FIG. 5 is a diagram showing various kinds of data constituting a servo frame;

FIG. 6 is a schematic diagram showing a track format of a magnetic disc;

FIG. 7 is a diagram showing a construction of a servo track writer for recording a servo frame on a magnetic disc;

FIG. 8 is a diagram showing an n-th track on a magnetic disc;

FIG. 9 is a diagram showing an (n+1)-th track on a magnetic disc;

FIG. 10 is a diagram showing a construction of a hard disc device;

FIGS. 11A, 11B and 11C are schematic diagrams showing images of PES data and RRO correction data; and

FIG. 12 is a schematic diagram showing a track format of a magnetic disc.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Preferred embodiments according to the present invention will be described.

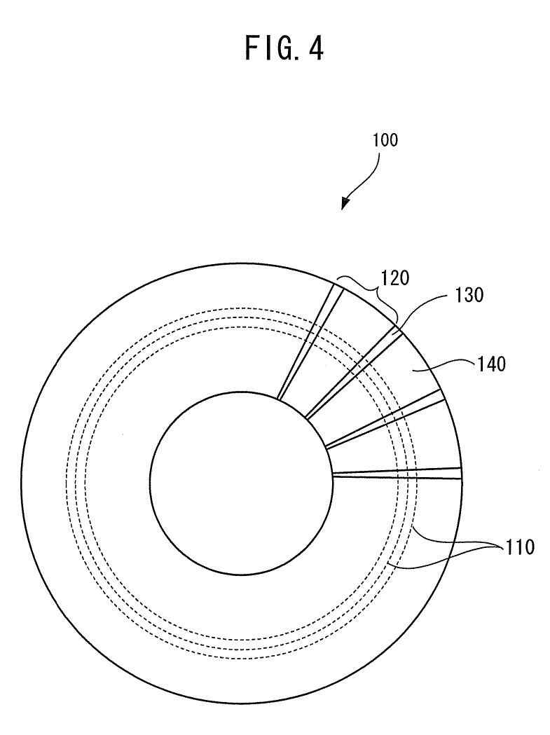

FIG. 4 is a diagram showing data recorded on a magnetic disc 100.

As shown in FIG. 4, plural concentric tracks 110 are provided on the magnetic disc 100. The recording area of the magnetic disc 100 is divided into plural sectors 120 in the peripheral direction of the track 110. A servo frame 130 used for head positioning, etc. is recorded at the head of each sector 120, and user data 140 as an access target is recorded after the servo frame 130. The magnetic disc 100 corresponds to an example of a recording medium in a RRO correction information recording method, a RRO correction information recording circuit and an information storage device described above, and the servo frame 130 corresponds to an example of a servo frame in the RRO correction information recording method, the RRO correction information recording circuit and the information storage device described above.

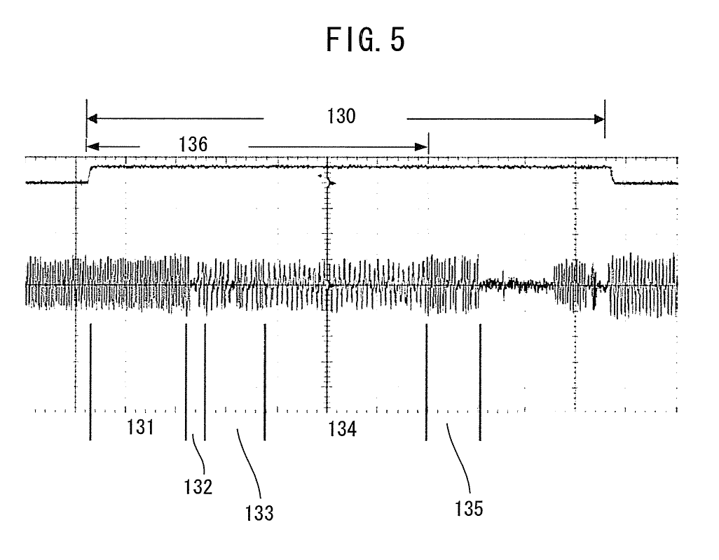

FIG. 5 is a diagram showing various kinds of data constituting the servo frame 130.

As shown in FIG. 5, the servo frame 130 comprises a preamble 131 for adjusting the frequency and the amplitude, a servo mark 132 having a data pattern common to all the sectors 120, a gray code 133 representing a number of the track 110 (track number), PES data 134 for detecting a positional displacement amount from a center of the track 110, RRO correction data 135 for correcting a stationary positional displacement of the servo frame 130, etc. The position data 136 comprising the assembly of the preamble 131, the servo mark 132, the gray code 133 and the PES data 134 can be read out from the magnetic disc 100 even when the magnetic head is located at any position above the magnetic disc 100.

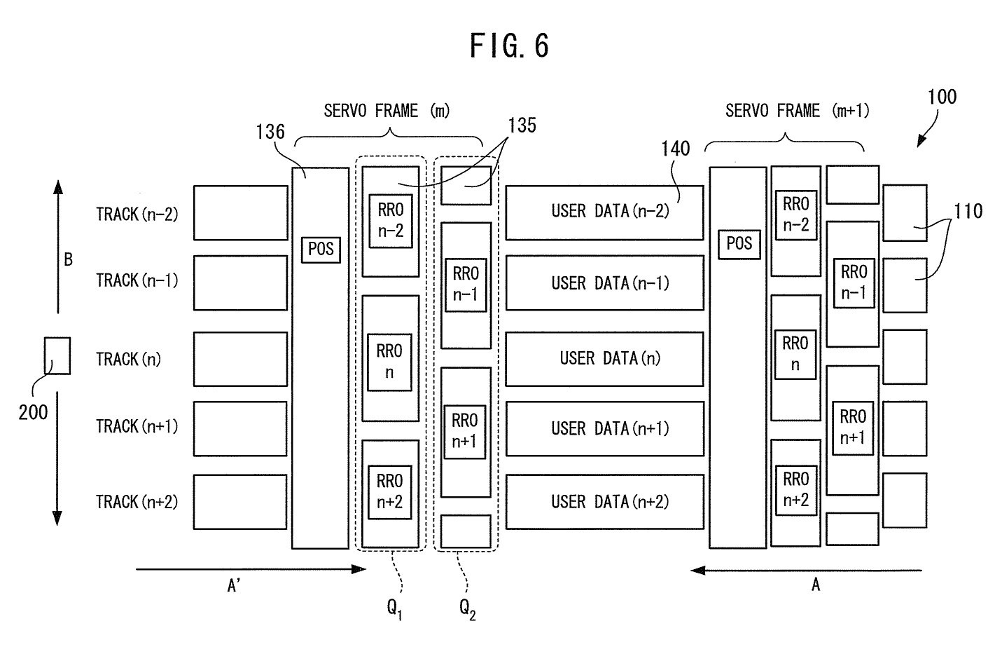

FIG. 6 is a schematic diagram showing a track format of the magnetic disc 100.

The magnetic disc 100 is rotationally driven in the direction of an arrow A, and a head 200 scans the magnetic disc 100 along the track 110 in the direction of an arrow A′. Each servo frame 130 (FIG. 5) is recorded on the magnetic disc 100 so as to stride over plural tracks 110, and the user data 140 is recorded at the rear side of the servo frame 130 on every track 110.

The position data 136 in the servo frame 130 is recorded commonly to all the tracks 110. The RRO correction data 135 are recorded so as to bridge (or overlap)tracks adjacent to the corresponding track 110 and alternately recorded in each of a front-side area Q1 and a rear-side area Q2 into which the RRO correction data area is divided in a peripheral direction of the track 110. That is, the RRO correction data 135_{—}n corresponding to the n-th track 110_{—}n is recorded in the front-side area Q1 so as to bridge the adjacent (n−1)-th and (n+1)-th tracks 110_(n−1) and 110_(n+1), and the RRO correction data 135_(n−1) corresponding to the (n−1)-th track 110_(n−1) just before the n-th track 110_{—}n is recorded in the rear-side area Q2 so as to bridge the adjacent n-th and (n−2)-th tracks 110_{—}n and 110_(n−2). Furthermore, the RRO correction data 135_(n+1) corresponding to the (n+1)-th track 110_(n+1) just after the n-th track 110_{—}n is recorded in the rear-side area Q2 so as to bridge the adjacent n-th and (n+2)-th tracks 110_{—}n and 110_(n+2).

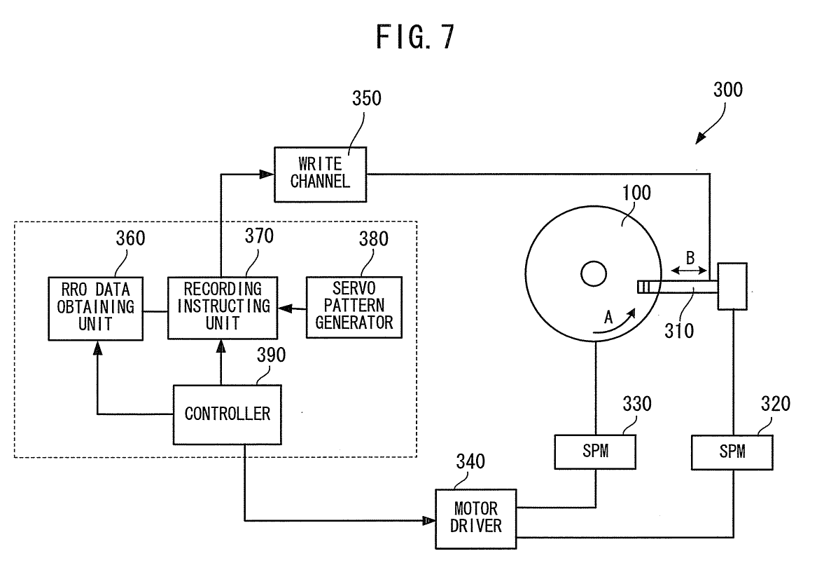

FIG. 7 is a diagram showing a construction of a servo track writer 300 for recording the servo frame 130 on the magnetic disc 100.

The servo track writer 300 has a spindle motor 330 for rotating the magnetic disc 100, a magnetic head 310 for executing information access to the magnetic disc 100, a voice coil motor 320 for moving the magnetic head 310 along a surface of the magnetic disc 100, a write channel 350 for generating writing current representing the servo frame 130 to be written into the magnetic disc 100, a motor driver 340 for driving the spindle motor 330 and the voice coil motor 320, a servo pattern generator 380 for generating the position data 136 (FIG. 6), an RRO data obtaining unit 360 which is connected to an RRO detecting device for detecting eccentricity of the magnetic disc 100, etc. and obtains the RRO correction data 135 from the RRO detecting device, a recording instructing unit 370 for indicating a writing position of the RRO correction data 135, and a controller 390 for controlling the whole of the servo track writer 300. The recording instructing unit 370, according to an embodiment, corresponds to an example of the recording instructing unit in the RRO correction information recording circuit and the information storage device, and the write channel 350 corresponds to an example of the recording unit in the RRO correction information recording circuit and the information storage device.

When the servo frame 130 is recorded in the magnetic disc 100, the magnetic disc 100 is first mounted on the servo track writer 300.

Subsequently, according to the instruction from the controller 390, the motor driver 340 drives the spindle motor 330 to rotate the magnetic disc 100 in the direction of the arrow A, and also drives the voice coil motor 320 to position the magnetic head 310 to a predetermined track 110 on the magnetic disc 100.

When the magnetic head 310 is positioned, the position data 136 in the servo frame 130 is generated in a servo pattern generator 380. The generated position data 136 is transmitted to the write channel 350.

In the write channel 350, writing current carrying position information represented by the position data 136 is generated, and the writing current is applied to the magnetic head 310.

In the magnetic head 310, magnetic field whose orientation corresponds to the writing current is generated, and the magnetic flux corresponding to the magnetic field is emitted to the magnetic disc 100. As a result, magnetization whose orientation corresponds to the information concerned is formed on the magnetic disc 100, thereby recording the position data 136 on the magnetic disc 100.

The magnetic head 310 is positioned onto the target track 110 according to the instruction from the controller 390, and a series of processing of recording the position data 136 at each sector on the target track 110 is executed on all the tracks 110 of the magnetic disc 100.

When the position data 136 are recorded on the magnetic disc 100 as described above, recording of the RRO correction data 135 is subsequently started.

When the RRO correction data 135 are recorded, the magnetic head 310 is first positioned to a predetermined track 110 on the magnetic disc 100 according to the instruction from the controller 390.

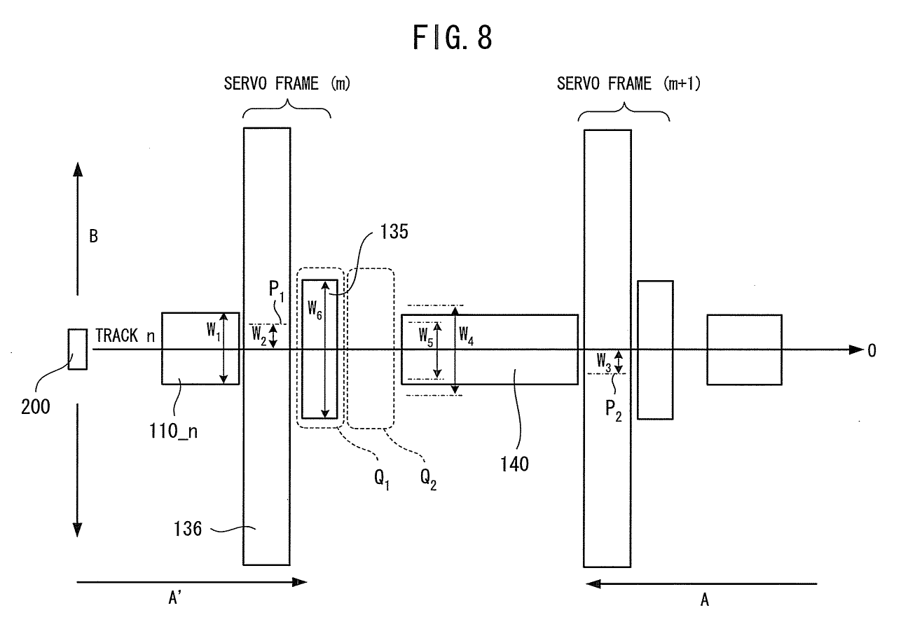

FIG. 8 is a diagram showing the n-th track 110_{—}n on the magnetic disc 100.

In some cases the position data 136 is not necessarily stably recorded due to the vibration of the servo track writer 300 or the displacement of the rotational axis, etc. when the magnetic disc 100 is mounted on the servo track writer 300. Therefore, the positions P1, P2 of the track center represented by the PES data 134 in the position data 136 are displaced from the center position of the actual track 110_{—}n. The displacement amount W2 (W3) between the position P1 (P2) of the track center represented by the PES data 134 in the position data 136 and the track center O is detected by the RRO detecting device.

In the RRO data obtaining unit 360 (FIG. 7), the positional displacement amounts W2, W3 detected by the RRO detecting device are obtained as the RRO correction data 135. The obtained RRO correction data 135 are transmitted to the recording instructing unit 370.

The recording instructing unit 370 transmits to the write channel 350 an instruction of recording the RRO correction data 135_{—}n corresponding to the n-th track 110_{—}n into the front-side area Q1 out of the two areas Q1, Q2 prepared behind the position data 136.

In FIG. 8, when the track center positional displacement represented by the PES data 134 is within the correction range W5, the position of the magnetic head 200 can be corrected by using the RRO correction data 135_{—}n. Furthermore, the on-track width W4 for judging that the magnetic head 200 is located above the track 110_{—}n is shorter than the track pitch W1 of the track 110_{—}n. In the write channel 350, the RRO correction data 135_{—}n corresponding to the n-th track 110_{—}n is recorded at a relatively early timing with the width W6 larger than the on-track width W4. As a result, the RRO correction data 135_{—}n corresponding to the n-th track 110_{—}n is recorded in the front-side area Q1 out of the two areas Q1 and Q2 so as to bridge both the adjacent tracks 110_(n+1) and 110_(n−1). The n-th track 110_{—}n corresponds to an example of a first recording track in the RRO correction information recording method, the RRO correction information recording circuit and the information storage device, and the RRO correction data 135_{—}n corresponds to an example of first RRO correction information in the RRO correction information recording method, an RRO correction information recording circuit and the information storage device.

Subsequently, according to the instruction from the controller 390, the magnetic head 200 is moved to a position above the (n+1)-th track 110_(n+1).

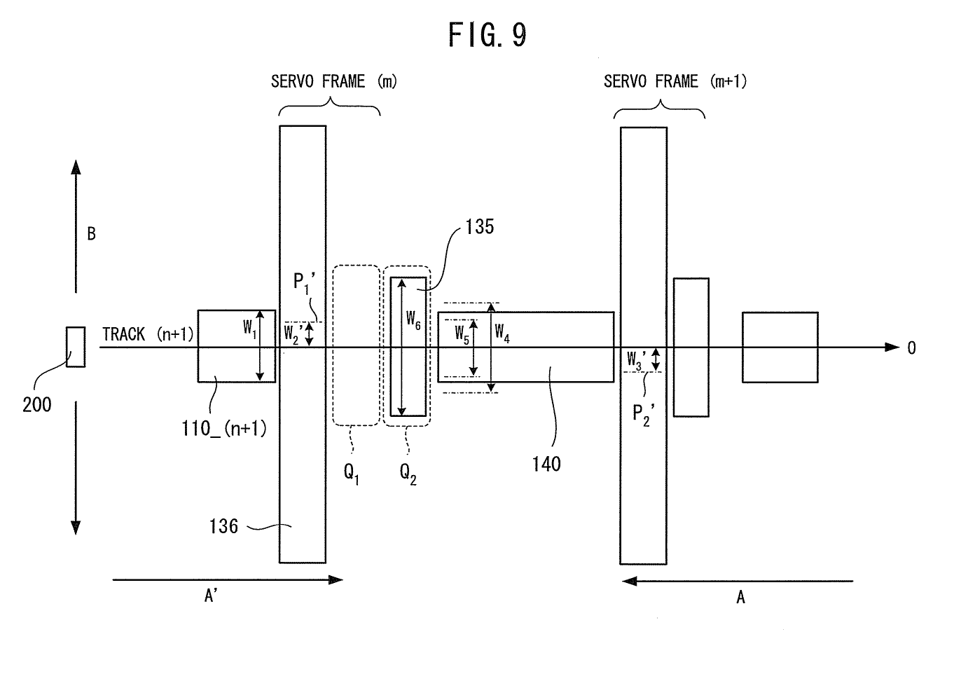

FIG. 9 is a diagram showing the (n+1)-th track 110_(n+1) on the magnetic disc 100.

At the (n+1)-th track 110_(n+1), the positional displacement amount W2′ (W3′) between the position P1′ (P2′) of the track center represented by the PES data 134 in the position data 136 and the center position of the actual track 110_{—}n is obtained as the RRO correction data 135_(n+1) in the RRO data obtaining unit 360.

The recording instructing unit 370 transmits to the write channel 350 an instruction of recording the RRO correction data 135_(n+1) corresponding to the (n+1)-th track 110_(n+1) into the rear-side area Q2.

In the write channel 350, the RRO correction data 135_(n+1) corresponding to the (n+1)-th track 110_(n+1) is recorded at a relatively late timing with a width W6 larger than the on-track width W4. As a result, the RRO correction data 135_(n+1) corresponding to the (n+1)-th track 110_(n+1) is recorded in the rear-side area Q2 out of the two areas Q1 and Q2 so as to bridge the adjacent tracks 110_{—}n and 110_(n+1). The (n+1)-th track 110_(n+1) corresponds to an example of a second recording track in the RRO correction information recording method, the RRO correction information recording circuit and the information recording device described above, and the RRO correction data 135_(n+1) corresponds to an example of second RRO correction information in the RRO correction information recording method, the RRO correction information recording circuit and the information recording device.

As described above, the RRO correction data 135 are alternately recorded in each of the two areas Q1 and Q2 on the magnetic disc 100 so as to bridge the tracks adjacent to the corresponding track 110. When all the servo frames 130 are recorded, the magnetic disc 100 is detached from the servo track writer 300, and mounted in a hard disc device 400 equipped with the magnetic head 200.

Subsequently, a description will be given of a series of processing for accessing to data recorded in the magnetic disc 100.

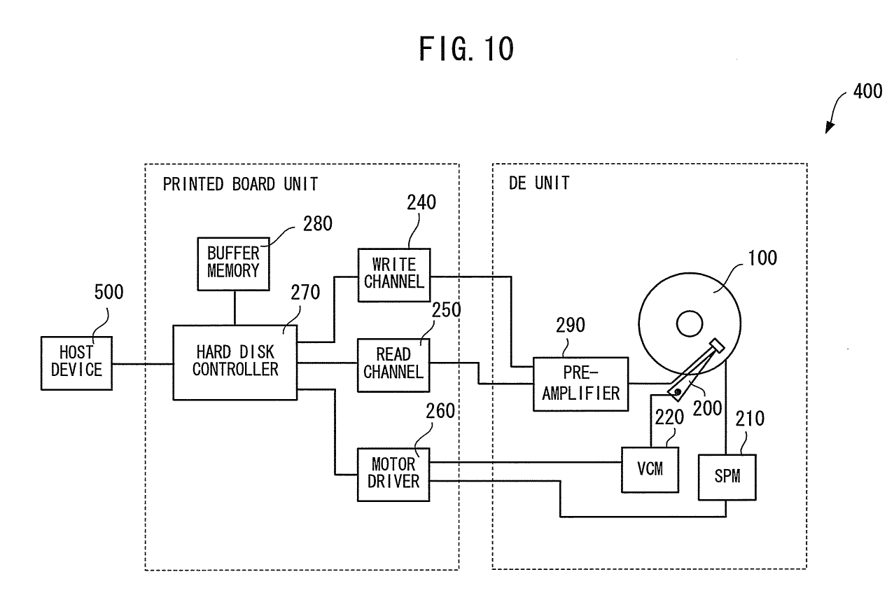

FIG. 10 is a diagram showing a construction of a hard disc device 400.

The hard disc device 400 is configured to access to the magnetic disc 100, and connected to a host device 500 represented by a personal computer, etc., or incorporated into the host device 500 in use.

The hard disc device 400 is equipped with the magnetic disc 100 on which the servo frames 130 are recorded, a spindle motor 210 for rotating the magnetic disc 100, the magnetic head 200 for executing information access to the magnetic disc 100, a voice coil motor 220 for moving the magnetic head 200 along the surface of the magnetic disc 100, a pre-amplifier 290 for amplifying a reproduction signal read out by the magnetic head 200, a write channel 240 for generating writing current representing recording data to be written into the magnetic disc 100, a read channel 250 for demodulating a reproduction signal to digital data, a motor driver 260 for driving the spindle motor 210 and the voice coil motor 220, a hard disc controller 270 for transmitting/receiving data to/from the host device 500, and a buffer memory 280 used in the hard disc controller 270.

When information access is executed on the magnetic disc 100, the motor driver 260 first drives the spindle motor 210 to rotate the magnetic disc 100, and also drives the voice coil motor 220 to move the magnetic head 200 to a position above the magnetic disc 100.

In the magnetic head 200, the position data 136 in the servo frame 130 is obtained before the user data 140 is obtained, and the magnetic head 200 is moved in the radial direction (in the direction of the arrow B in FIG. 8) until the track number represented by the gray code 133 in the position data 136 is coincident with the track number of the target track 110 as the access target.

When the magnetic head 200 is moved to a position above the target track 110, a timing of reading out the RRO correction data 135 is indicated from the hard disc controller 270 to the read channel 250. When the track number N of the target track 110 is an even number, an instruction of reading out the RRO correction data 135 at a relatively early timing is transmitted. When the track number N of the target track 110 is an odd number, an instruction of reading out the RRO correction data 135 at a relatively late timing is transmitted. In the read channel 250, the RRO correction data 135 is read out at the instructed timing. That is, when the target track 110 is the n-th track 110-n shown in FIG. 8, the RRO correction data 135_{—}n is recorded in the front-side area Q1, and thus the RRO correction data 135_{—}n is read out at a relatively early timing. When the target track 110 is the (n+1)-th track 110_(n+1) shown in FIG. 9, the RRO correction data 135_(n+1) is recorded in the rear-side area Q2, and thus the RRO correction data 135_(n+1) is read out at a relatively late timing.

As described above, according to an embodiment, the RRO correction data 135_{—}n, 135_(n+1) corresponding to the adjacent tracks 110_{—}n, 110_(n+1) are recorded in the different areas Q1 and Q2 in the peripheral direction. Therefore, by adjusting the reading timing of the RRO correction data 135_{—}n, 135_(n+1), the disadvantage that the erroneous RRO correction data 135 is obtained can be prevented. Furthermore, the width W6 over which the RRO correction data 135_{—}n, 135_(n+1) are recorded is larger than the track pitch W1, and further larger than the on-track width W4, so that the RRO correction data 135_{—}n, 135_(n+1) can be surely read out.

When the RRO correction data 135 is read out, the magnetic head 200 is more minutely positioned by using the RRO correction data 135 concerned and the PES data 134 in the position data 136.

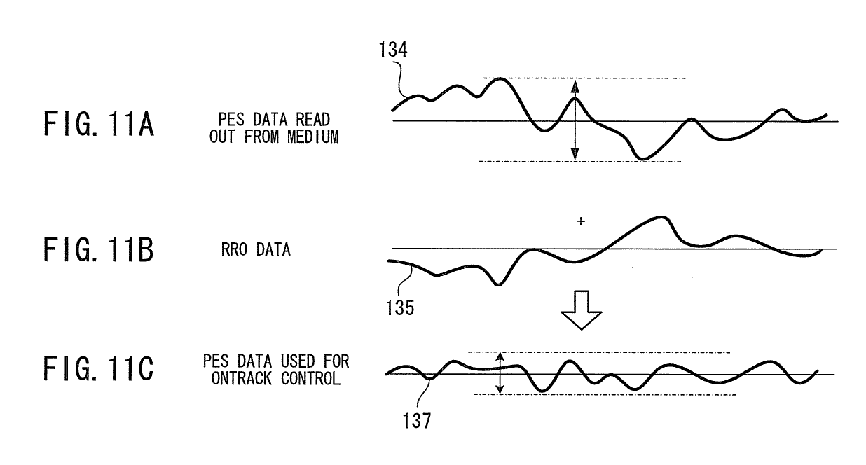

FIG. 11 is a schematic diagram showing images of the PES data 134 and the RRO correction data 135.

As shown in FIG. 11A, the locus of the track center represented by the PES data 134 in the position data 136 has a rugged positional displacement as compared with the actual track center O.

In the hard disc controller 270, the PES data 134 shown in FIG. 11A is added with the RRO correction data 135 shown in FIG. 11B to generate the corrected PES data 137 shown in FIG. 11C. The thus-generated corrected PES data 137 is nearer to the track center O as compared with the pre-correction PES data shown in FIG. 11A.

The magnetic head 200 is moved in the radial direction (in the direction of the arrow B in FIG. 8) while following the corrected PES data 137. As a result, the magnetic head 200 apparently moves in the direction of the arrow A′ above the track center O.

When the position of the magnetic head 200 is set to the position above the track center O of the target track 110 as described above, the actual information access is executed.

As described above, according to an embodiment, correct RRO correction data can be surely read out by the magnetic head, and the position of the magnetic head can be positioned onto the target track with high precision.

The description of an embodiment of the present invention is finished here, and another embodiment according to the present invention will be next described. In this embodiment, the same elements as the above-described embodiment are represented by the same reference numerals, the description thereof is omitted and only the difference from the above-described embodiment will be described.

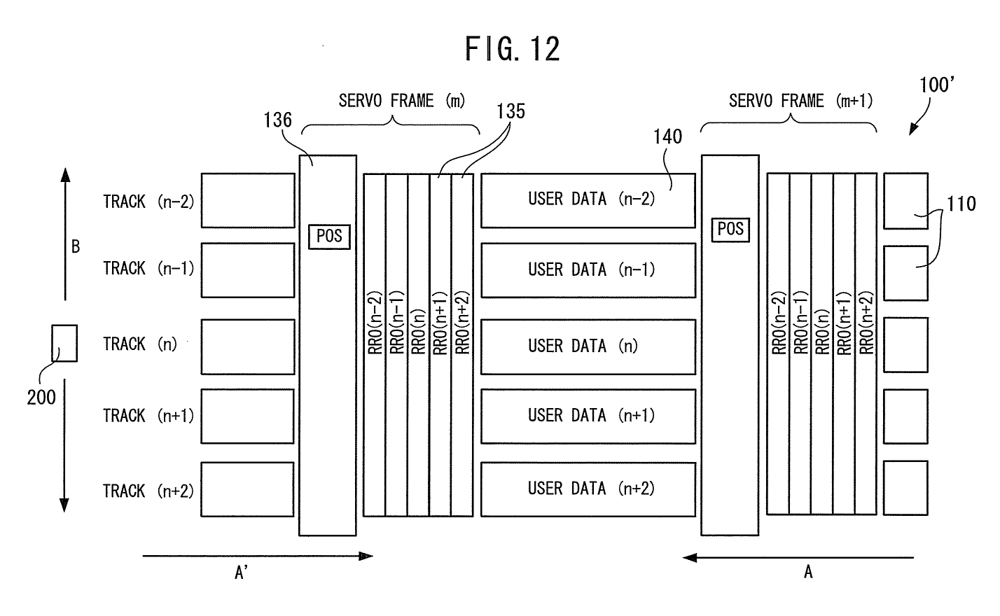

FIG. 12 is a schematic diagram showing a track format of the magnetic disc 100 according to an embodiment.

A magnetic disc 100′ according to an embodiment shown in FIG. 12 is different from the magnetic disc 100 of the above-described embodiment shown in FIG. 6 in that plural RRO correction data 135 corresponding to plural tracks 110 are recorded so as to be successively arranged in the order of (n−2)-th RRO correction data 135_(n−2), (n−1)-th RRO correction data 135_(n−1), . . . , (n+2)-th RRO correction data 135_(n+2), and each RRO correction data 135 passes over all the tracks 110.

When the information access is executed on the magnetic disc 100′, the magnetic head 200 is first moved onto the target track 110, and a reading timing of the RRO correction data 135 is instructed from the hard disc controller 270 shown in FIG. 10 to the read channel 250. In an embodiment, as the track number N of the target track 110 is smaller, the instruction of reading out the RRO correction data at a relatively earlier timing is transmitted. In the read channel 250, when the target track 110 is the (n−2)-th track 110_(n−2) having a smaller track number, the RRO correction data 135_(n−2) is read out by instructing an earlier timing. When the target track 110 is the (n−1)-th track 110_(n−1), the RRO correction data 135_(n−1) is read out by instructing a later timing than the (n−2)-th track 110_(n−2). When the target track 110 is the n-th track 110_{—}n, the RRO correction data 135_{—}n is read out by instructing a later timing than the (n−1)-th track 110_(n−1). When the target track 110 is the (n+1)-th track 110_(n+1), the RRO correction data 135_(n+1) is read out by instructing a timing later than the n-th track 110-n. When the target track 110 is the (n+2)-th track 110_(n+2), the RRO correction data 135_(n+2) is read out by instructing a timing later than the (n+1)-th track 110_(n+1).

As described above, according to an embodiment, plural RRO correction data corresponding to plural tracks are recorded in different peripheral directions so as to pass over all the tracks, whereby a width over which the RRO correction data are recorded is increased, and thus the RRO correction data can be surely read out. Furthermore, according to this embodiment, the timing of reading out the RRO correction data can be easily controlled, and the disadvantage that the erroneous RRO correction data are obtained can be surely prevented.

In the foregoing description, the magnetic disc in which information is recorded by using magnetic field is applied as a recording medium. However, the recording medium in the information access device described above may be a recording medium such as MO for recording information with light or the like.

The embodiment described above is a preferred exemplary embodiment. The present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. A method of recording RRO correction information on a recording medium comprising:
recording first RRO correction information corresponding to a first recording track on a first track in one of plural servo frames; and
recording second RRO correction information corresponding to a second recording track different from the first recording track on a second track at a position different from a position of the first RRO correction information with respect to a time axis in a servo frame concerned.

2. The RRO correction information recording method according to claim 1, wherein the first track and the second track are adjacent to each other.

3. The RRO correction information recording method according to claim 2, wherein RRO correction information is recorded on plural tracks so as to be alternately displaced in a radial direction of the magnetic disc.

4. The RRO correction information recording method according to claim 2, wherein RRO correction information corresponding to a track is recorded so as to bridge two tracks adjacent to the track concerned.

5. The RRO correction information recording method according to claim 1, wherein plural RRO correction data corresponding to plural tracks are recorded in different time axis so as not to interfere mutually over all tracks.

6. An RRO correction information recording circuit for recording RRO correction information on a recording medium, comprising:
a recording instructing unit for instructing to record first RRO correction information corresponding to a first recording track on a first track in one of plural servo frames, and instructing to record second RRO correction information corresponding to a second recording track different from the first recording track on a second track at a position different from a position of the first RRO correction information with respect to a time axis; and
a recording unit for recording RRO correction information in response to an instruction of the recording instructing unit.

7. An information recording device, comprising:
a recording medium in which plural servo frames are intermittently provided along a time axis of the recording medium; and
an RRO correction information recording circuit including:
a recording instructing unit for instructing to record first RRO correction information corresponding to a first recording track on a first track in one of the plural servo frames, and instructing to record second RRO correction information corresponding to a second recording track different from the first recording track on a second track at a position different from a position of the first RRO correction information with respect to the time axis, and
a recording unit for recording RRO correction information in response to an instruction of the recording instructing unit.

8. A method of recording correction information, comprising:
recording correction data over adjacent tracks of a storage medium at alternate positions of the adjacent tracks with respect to a time axis of a target track; and
controlling a reading of the correction data recorded by adjusting a timing of the reading from the target track relative to reading of the adjacent tracks.
